(19) United States
(12) Patent Application Publication
(10) Pub. No.: US 2010/0262662 A1
(43) Pub. Date: Oct. 14, 2010

(54) OUTBOUND SPAM DETECTION AND PREVENTION

(75) Inventor: Tak Yin Wang, Los Altos, CA (US)

Correspondence Address: Weaver Austin Villeneuve & Sampson - Yahoo!, P.O. BOX 70250, OAKLAND, CA, 94612-0250, US

(73) Assignee: Yahoo! Inc., Sunnyvale, CA (US)

(21) Appl. No.: 12/422,101

(22) Filed: Apr. 10, 2009

(51) Int. Cl. G06F 15/16

(52) U.S. Cl. 709/206

(57) ABSTRACT

A usage control mechanism is disclosed for use in deterring automated “bot” access. When implemented within an email or messaging system, the mechanism and system prevents generation of spam by the bots, while also minimizing collateral deterrence of desirable human usage. In a disclosed embodiment, a reference image is part of a message composition screen, and a message may be composed but not sent unless a user selects, from a plurality of screening images, an image containing an alphanumeric string or other object that matches that of the reference image.

### BACKGROUND OF THE INVENTION

This invention relates generally to access control and email, and more specifically to minimizing the amount of spam traffic over an email system.

More than 75% of all email traffic on the internet is spam. To date, spam-blocking efforts have taken two main approaches:(1) content-based filtering and (2) IP-based blacklisting. Both of these techniques are losing their potency as spammers become more agile. Spammers evade IP-based blacklists with nimble use of the IP address space such as stealing IP addresses on the same local network. Dynamically assigned IP addresses together with virtually untraceable URL's make it increasingly more difficult to limit spam traffic. For example, services such as www.tinyurl.com take an input URL and create multiple alias URL's by hashing the input URL. The generated hash URL's all take a user back to the original site specified by the input URL. When a hashed URL is used to create an email or other account, it is very difficult to trace back as numerous hash functions can be used to create a diverse selection of URL's on the fly.

To make matters worse, as most spam is now being launched by automated routines or “bots,” spammers can send a large volume of spam in aggregate while only sending a small volume of spam to any single domain from a given IP address. The “low” and “slow” spam sending pattern and the ease with which spammers can quickly change the IP addresses from which they are sending spam has rendered today's methods of blacklisting spamming IP addresses less effective than they once were.

While captchas are a well accepted way to limit automated access, many captchas are overly effective at deterring legitimate users.

### SUMMARY OF THE INVENTION

The disclosed embodiments quickly detect usage of accounts by automated bots, for example to generate spam email. This reduces the necessary infrastructure of, for example, an email system, as the volume of junk mail is drastically reduced and more of the infrastructure is used for legitimate traffic.

The effectiveness in preventing bot usage does not come at the expense of preventing legitimate human usage. That is to say, the mechanism is easier for humans to navigate than prior mechanisms to deter bots. For example the disclosed embodiments result in lesser fraction of humans not being able to solve captchas, as typically used to thwart bots.

A test according to the disclosed embodiments may be incorporated into a user interface and back end infrastructure in order to minimize automated use or abuse of the system. While the disclosed embodiments relate to an email system, it should be appreciated that such a mechanism may be utilized in many other contexts as a limitation to a command by the user to the system to perform an action, in an attempt to verify human usage and limit the usage to humans.

The mechanism may be permanently employed, or alternatively may apply to new accounts that have not yet received a “trusted” status, or alternatively to accounts that are marked as “suspicious” and may have lost “trusted” status.

According to one embodiment, a computer system for providing messaging or email to a group of users is disclosed. The computer system is configured to: cause a message composition screen of a user interface to be rendered at a client computer; cause a reference image comprising an alphanumeric string within the image to appear within the message composition screen; cause a first plurality of screening images comprising an alphanumeric string within each of the first plurality of screening images to contemporaneously appear within the message composition screen, each screening image of the first plurality differing from each other image of the first plurality; and prevent a user from sending a message if the user selects a screening image of the first plurality comprising an alphanumeric string that does not match the alphanumeric string within the reference image.

According to another embodiment, a computer system for providing messaging or email to a group of users is configured to: open an email account for a user; establish a probationary period for the user; and provide probationary access to the user during the probationary period. The probationary access comprises a first message composition interface having a reference image comprising a reference alphanumeric string, a group of send button tags, and a group of screening images, each screening image corresponding to a send button tag of the group of send button tags. The computer system is further configured to determine that the probationary period has lapsed and provide non-probationary access comprising a second composition interface different from the first composition interface.

A further understanding of the nature and advantages of the present invention may be realized by reference to the remaining portions of the specification and the drawings.

### BRIEF DESCRIPTION OF THE DRAWINGS

FIG. 1 illustrates a flow chart of a process according to an embodiment of the invention.

FIGS. 2A and 2B illustrate flow charts of a processes according to embodiments of the invention.

FIGS. 3A and 3B illustrate graphical user interfaces for composing and sending email at a client computer, according to embodiments of the invention.

FIG. 4 is a simplified diagram of a computing environment in which embodiments of the invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Conventional wisdom on deterring spam involves introducing ever more difficult captchas. The ideal captcha is very difficult for a bot to decipher but easy enough for a human to decipher. In reality, as the bots and other nefarious users improve the techniques for automatically or rapidly deciphering captchas, the captchas are increasingly made more difficult in order to thwart such spam generators. This results in more difficult captchas for legitimate human users as well.

Embodiments of the present invention are effective at minimizing spam traffic, while at the same time less effective at deterring legitimate users. That is to say, they provide less of a hindrance to legitimate users, while still effectively deterring and reducing unwanted spam. This frees up network resources for legitimate email traffic and minimizes capital expenditures for infrastructure spent to increase capacity, much of which is utilized undesirably for spam.

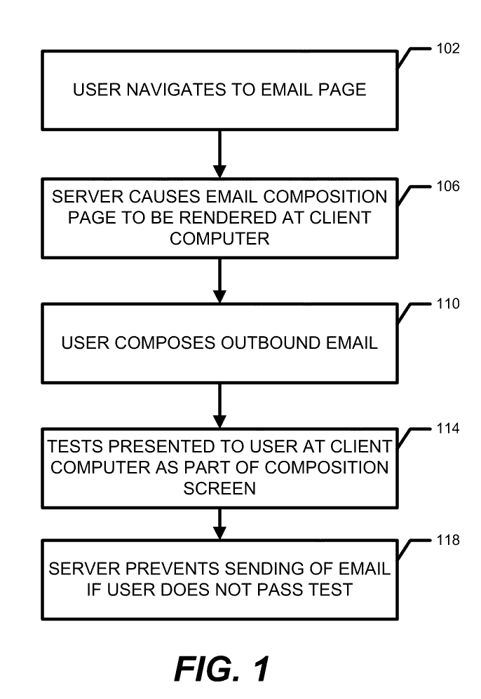

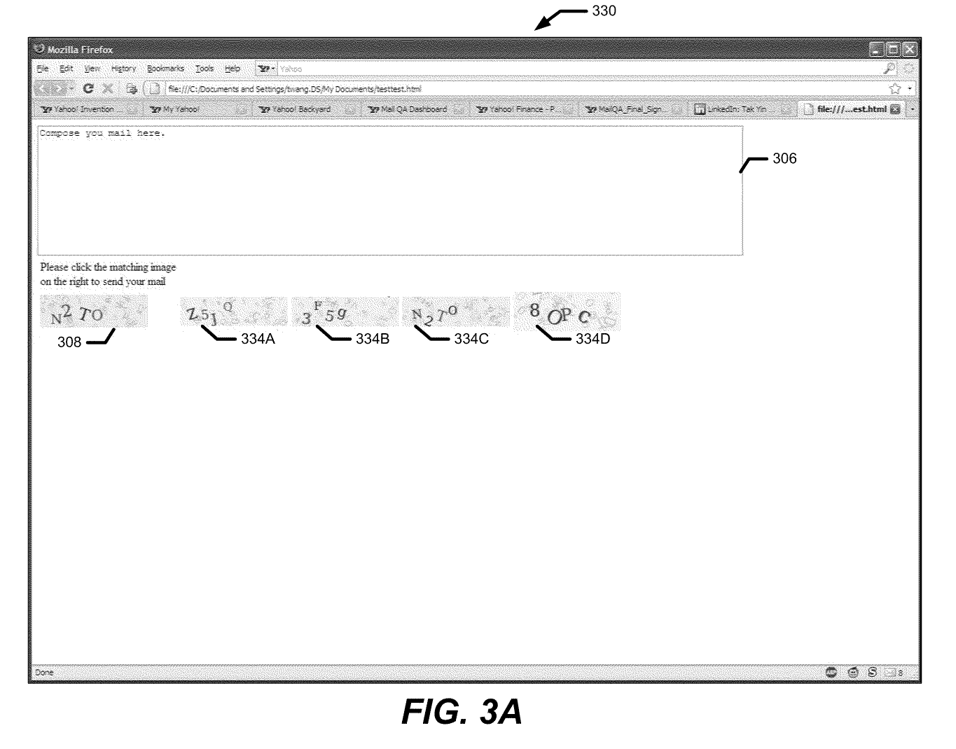

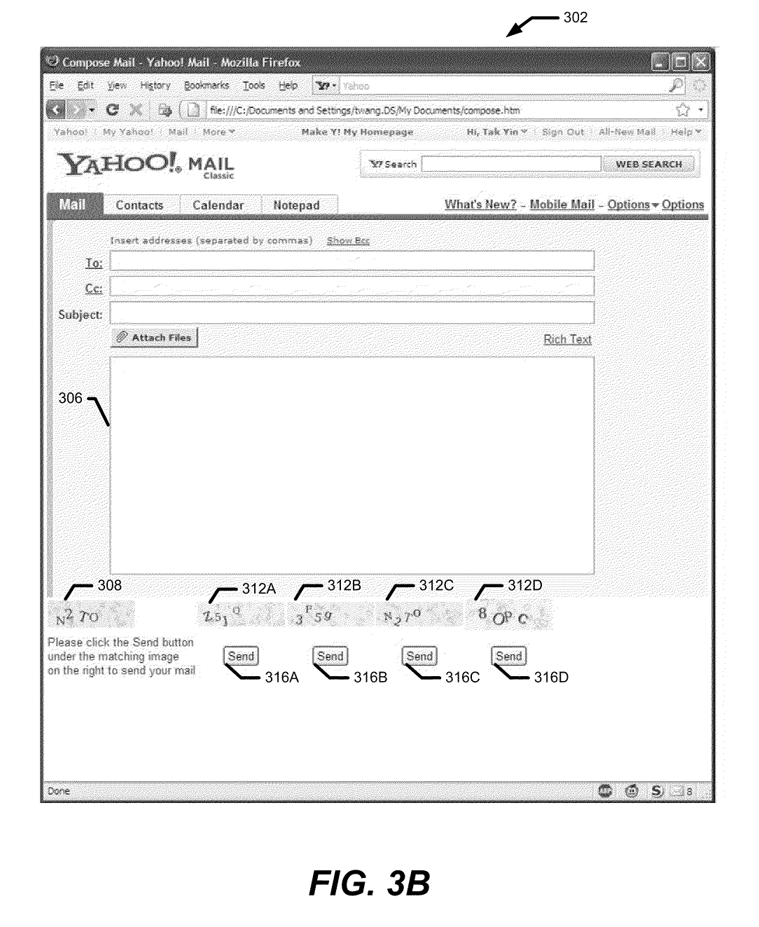

FIG. 1 illustrates a flow chart of a process according to an embodiment of the invention. In step 102, a user navigates to an email composition page of an email provider, such as that of Yahoo!. Embodiments of email composition pages are shown in FIGS. 3A and 3B. As part of this the user generally begins at a higher level mail interface where the user may decide to read, compose, delete, or otherwise manage their email. When the user indicates that they wish to compose a new email or reply, or forward a message, through one or more clicks on a graphical user interface, a command is sent from the client computer the user is accessing to the email server system. The server computer then causes the email composition page to be rendered at the client computer, as seen in step 106. In step 110, the user then composes an outbound email message. Then, in step 114, one or more tests are presented to the user at the client computer as part of the composition screen. The user must successfully complete the tests in order for the email message to be sent. If the user does not successfully complete the test, the server prevents sending of the email message, as seen in step 118. Any number and/or type of tests that are designed to be difficult for bots but not overly burdensome or confusing to a human user may be employed. A few exemplary embodiments of such a test and its implementation in a mail system will be described below, although it should be understood that the present application should not be limited to the described embodiments.

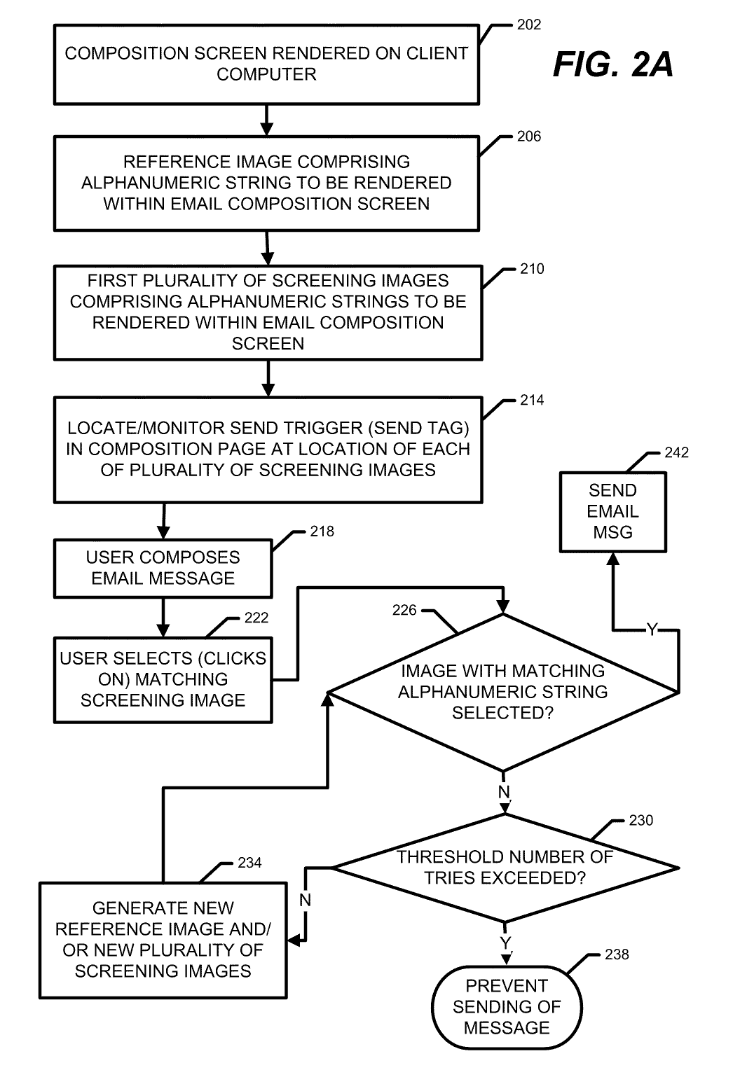

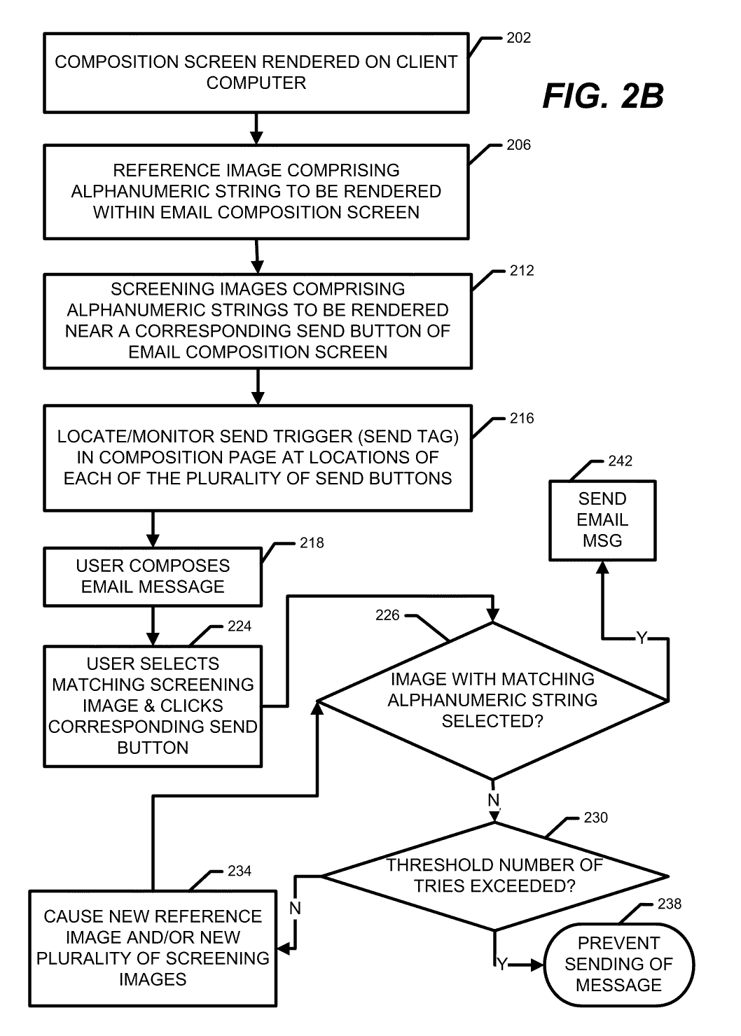

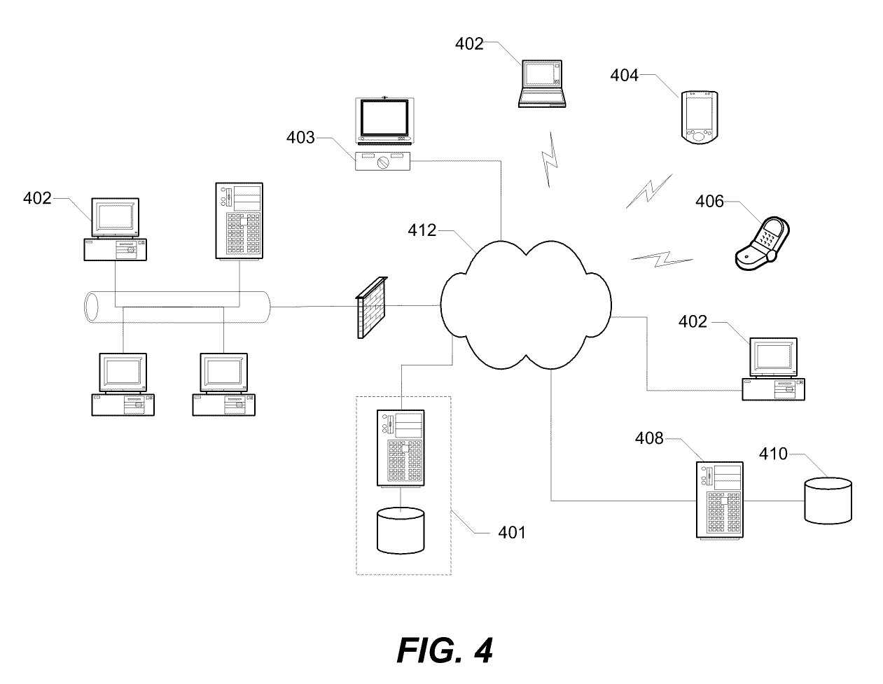

The flow chart of FIG. 2A corresponds to the user interface shown in FIG. 3A, which should be viewed in tandem. In step 202, an email composition screen is rendered on a client computer. As mentioned above, the email server/system triggers this at the client computer in response to one or more commands at the client. In step 206, the server causes a reference image 308 comprising an alphanumeric string to be rendered within the email composition screen 330. The email server/system also causes a first plurality of screening images 334 (A . . . D) comprising alphanumeric strings to appear within email composition screen 330. A send trigger, typically in the form of a send <button> tag (not shown) in a browser based application, is placed at the location of each of the images 334A-D, as represented by box 214. In embodiments where the email system is accessed by a web browser, for example, an attribute for the button should be specified, and the default type for Internet Explorer is “button,” while in other browsers and specifications it is “submit.” It should be understood that the email servers/system (described later with regard to FIG. 4) may be accessed with client applications other than browsers.

In FIG. 3A, image 334C contains the alphanumeric string “N2TO” that matches that of reference image 308. While the matching “clickable” image contains the same string, the matching image (334A, B, C, or D etc.) itself is preferably different than that of the reference image. For example, the clickable image may be of different size than the base image, i.e., a pixel to pixel comparison or comparison of pixels in the proximity would likely fail. The clickable image could be rotated, or have some portion of the image or string be rotated in respect to another portion, in order to make object identification difficult. Also, RGB values of one or more of the pixels may be twisted in some manner so that the color may look the same/different to human eyes. A block of pixels (e.g. 2×2, 3×3, 4×4) can also be interchanged so that the shape of the same objects in the reference and clickable images may look different to a bot, but are still easily recognizable by human eyes.

Other manipulations that make the reference image and the matching clickable image look different pixel by pixel, but contain the key elements in similar order, but not necessarily in the same location, color, orientation, etc may also be employed. For further information on image manipulation of such images, please refer to U.S. patent application Ser. No. 12/236,869 to Broder et al., entitled “GENERATING HARD INSTANCES OF CAPTCHAS,” the contents of which are hereby incorporated by reference in the entirety. While the use of matching alphanumeric strings is discussed in the exemplary embodiments herein, it should be understood that other underlying matching elements may be employed (e.g. shapes, objects, or creatures etc.) and the present invention should not be limited to matching alphanumeric strings.

Referring again to FIGS. 2A and 3A, in step 218 the user composes an email message 218 in composition area 306. In step 222, the user selects and clicks on the screening image (334 A, B, C, or D etc.) he or she believes contains the matching alphanumeric to that of reference image 308. The group of screening images may comprise 2 or more screening images, although 3-5 are preferable. If, as seen in step 226, the image with the matching alphanumeric is clicked upon, the email message will be sent, as shown in box 242. If however, the user does not select the matching screening image, the email system will then determine if a threshold number of tries has been exceeded in step 230. The threshold may be anywhere from 1 to 10, for example. If it has not been exceeded, the user will get another chance to send his or her email message, and the system will cause a new reference image and/or a new plurality of screening images to be generated, as seen in step 334, and the process returns to step 226. If, however the threshold number has been exceeded, the email system will prevent the sending of the message, as seen in step 238.

Such a mechanism prevents a bot from sending out a large volume of spam, as the bot will not easily be able to select from a group of screening images in order to send a composed email message. At the same time, this mechanism is easier for a human to properly utilize than the standard one at a time display of a captcha and subsequent typing in of the embedded string. Clicking at a wrong image more than 1 time per outbound mail is a strong indication of an automated bot behind the actions. Therefore, use of an account by a spammer may be indicated by counting the number of selections/clicks of a wrong (non matching) image/string per outbound mail and/or per day and/or per unit of time and/or per number of outbound messages sent. This should be a better indication of a spammer account than simply counting the number of messages sent from the account.

FIG. 3B shows another implementation of a user interface, email composition screen or interface 302, implementation of which is illustrated in the flowchart of FIG. 2B. In this interface, reference images 312 (A . . . D etc) are placed adjacent to send buttons 316 (A . . . D etc). As indicated in step 212 of FIG. 2B, the email server/system causes the screening images to appear near a corresponding send button of the email composition screen 302. The trigger or <button> tag (not shown) is thus collocated with the send button rather than the screening image, as shown in step 216. In contrast to the interface of FIG. 3A, the user will select the send button corresponding to the screening image containing the matching alphanumeric string, rather than clicking directly on the screening image, as seen in step 224. In FIG. 3B, in order to send the email, the user should click on send button 316C, below and corresponding to screening image 312C, having the matching alphanumeric string “N2TO” to reference image 308, in order to send the composed email message. The other steps of FIG. 2B numbered identically to those of FIG. 2A are otherwise the same as previously described with regard to FIG. 2A.

The mechanism of in the above described figures may be permanently employed, or may alternatively may apply to new (probationary) accounts that have not yet received a “trusted” status or alternatively to accounts that are marked as “suspicious” and perhaps have lost “trusted” status. Although it is described in the context of an email system, it may be used in any type of messaging system, or for that matter any system where submission/access control is desirable.

Additionally, the email system may in certain embodiments be configured to freeze an email account of a user prevented from sending an email message for a period of time, and to enable subsequent usage after said period ends.

Such an email system may be implemented as part of a larger network, for example, as illustrated in the diagram of FIG. 4. Implementations are contemplated in which a population of users interacts with a diverse network environment, accesses email and uses search services, via any type of computer (e.g., desktop, laptop, tablet, etc.) 402, media computing platforms 403 (e.g., cable and satellite set top boxes and digital video recorders), mobile computing devices (e.g., PDAs) 404, cell phones 406, or any other type of computing or communication platform. The population of users might include, for example, users of online email and search services such as those provided by Yahoo! Inc. (represented by computing device and associated data store 401).

Regardless of the nature of the email service provider, email may be processed in accordance with an embodiment of the invention in some centralized manner. This is represented in FIG. 4A by server 408 and data store 410 which, as will be understood, may correspond to multiple distributed devices and data stores. The invention may also be practiced in a wide variety of network environments including, for example, TCP/IP-based networks, telecommunications networks, wireless networks, public networks, private networks, various combinations of these, etc. Such networks, as well as the potentially distributed nature of some implementations, are represented by network 412.

In addition, the computer program instructions with which embodiments of the invention are implemented may be stored in any type of tangible computer-readable media, and may be executed according to a variety of computing models including a client/server model, a peer-to-peer model, on a stand-alone computing device, or according to a distributed computing model in which various of the functionalities described herein may be effected or employed at different locations.

The above described embodiments have several advantages. They are more user friendly to legitimate users of the email system. As bots and spammers have become more effective, captchas have also become more and more difficult in order to thwart the bots. This has the unintended consequence of thwarting a higher percentage of legitimate users, who often fail on the first attempt to solve the captcha. Allowing the user to select from a plurality of screening images eases the difficulty for the legitimate human users, while still providing effective deterrence to the bots.

Random guessing by an automated bot at the correct image of the screening images would result in ⅓ to ⅕ of the success rate (assuming 3-5 screening images) or a reduction of 60% to 80% of outbound spam. That dramatically cuts down the outbound spam volume. Increased speed of detection of a spammer is also possible with the described embodiments.

In the event that spammers successfully develop a program to decode the image correctly up to 80% of the time, on an average, there will be (0.8*0.8)=64% chance that both the reference and screening image are decoded correctly. Thus the spammer/bot will not decode correctly ⅓ of the time and therefore be detected. The screening mechanism in this example may detect two failure attempts for every six emails sent from an account, which results in extraordinarily fast detection as compared to prior techniques.

While the invention has been particularly shown and described with reference to specific embodiments thereof, it will be understood by those skilled in the art that changes in the form and details of the disclosed embodiments may be made without departing from the spirit or scope of the invention.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer system for providing email to a group of users, the computer system configured to:
cause an email composition screen of a user interface to be rendered at a client computer;
cause a reference image comprising an alphanumeric string within the image to appear within the email composition screen;
cause a first plurality of screening images comprising an alphanumeric string within each of the first plurality of screening images to contemporaneously appear within the email composition screen, each screening image of the first plurality differing from each other image of the first plurality; and
prevent a user from sending an email message if the user selects a screening image of the first plurality comprising an alphanumeric string that does not match the alphanumeric string within the reference image.

2. The computer system of claim 1, wherein the computer system is further configured to:
allow a user to send a composed email message if the user selects a screening image of the plurality comprising an alphanumeric string that matches the alphanumeric string within the reference image.

3. The computer system of claim 1, wherein the computer system is further configured to cause a plurality of send buttons to appear within the email composition screen, each of the plurality of screening images positioned adjacent a send button.

4. The computer system of claim 1, wherein the computer system is further configured to cause a plurality of send triggers to be embedded within the email composition screen, a send trigger of the plurality positioned at the same location as each of the plurality of screening images.

5. The computer system of claim 2, wherein the screening image having the alphanumeric string that matches the alphanumeric string of the reference image differs from the image by at least one pixel.

6. The computer system of claim 1, wherein the computer system is configured to maintain an account status for each user and upon a change from a probationary status to a non probationary status, the system is configured to substitute the email composition screen with a second email composition screen, the second email composition screen without the reference image and plurality of screening images, the computer system configured to cause the second email composition screen to be rendered at the client computer during a timeframe where the account is in a non probationary status.

7. The computer system of claim 1, wherein the computer system is configured to cause a second plurality of screening images comprising an alphanumeric string within each of the second plurality of screening images to contemporaneously appear within the email composition screen, each screening image of the second plurality differing from each other image of the second plurality and the first plurality.

8. The computer system of claim 1, wherein the computer system is further configured to disable an email account of a user prevented from sending an email message more than a threshold amount of times.

9. The computer system of claim 1, wherein the computer system is further configured to freeze an email account of a user prevented from sending an email message for a period of time, and to enable subsequent usage after said period ends.

10. A computer system for providing email to a group of users, the computer system configured to:
provide an email account for a user;
establish a probationary period for the user account;
provide probationary email access to the user during the probationary period, the probationary email access comprising:
a first email composition interface having a reference image comprising a reference alphanumeric string, a group of send button tags, and a group of screening images, each screening image corresponding to a send button tag of the group of send button tags;
determine that the probationary period has lapsed; and
provide non-probationary email access comprising a second composition interface different from the first composition interface.

11. The computer system of claim 10, wherein the reference image and screening images are part of a spam control mechanism, and wherein the second composition interface does not contain the spam control mechanism.

12. The computer system of claim 10, wherein each button tag of the group is adjacent a corresponding screening image.

13. The computer system of claim 10, wherein each button tag shares a location with a corresponding screening image, without an additional send button image for each button tag.

14. A computer implemented method of minimizing spam traffic on an electronic messaging system, the method comprising:
causing, with a server of the messaging system, a user interface for composing a message to be presented to a user on a client computer;
presenting a test to a sender to allow or disallow sending of a message once the message is composed, said test comprising a reference image and a plurality of test images displayed adjacent a send button,
the reference image and each of the test images comprising an alphanumeric string of alphanumeric characters,
one of the strings of the plurality of test images having a string matching the string in the reference image.

15. The computer implemented method of claim 14, further comprising:
determining if a user has selected the one of the plurality of test images with the matching string.

16. The computer implemented method of claim 15, further comprising:
sending the message if the user has selected the one of the plurality of test images.

17. The computer implemented method of claim 15, further comprising:
receiving a send command but not sending the message if the user has selected a test image other than the one of the plurality with the matching string.

18. A computer implemented method of minimizing spam traffic on an electronic messaging system, the method comprising:
causing, with a server of the messaging system, a user interface for composing a message to be presented to a user on a client computer;
presenting a test to a sender to allow or disallow sending of a message once the message is composed, said test comprising a reference image and a plurality of test images displayed adjacent a send button,
the reference image and each of the test images representing comprising an object therein, each of the images being unique from each of the other images,
one of the underlying objects of the plurality of test images having therein a matching object to that in the reference image, yet rendered differently than the reference image.
